(19) United States
(12) Patent Application Publication
(10) Pub. No.: US 2017/0249325 A1
(43) Pub. Date: Aug. 31, 2017

(54) PROACTIVE FAVORITE LEISURE INTEREST IDENTIFICATION FOR PERSONALIZED EXPERIENCES

(71) Applicant: MICROSOFT TECHNOLOGY LICENSING, LLC, Redmond, WA (US)

(72) Inventors: VIPINDEEP VANGALA, HYDERABAD (IN); RAVIKIRAN ARUN ARANKE, HYDERABAD (IN); KURUMADDALI VENKATA MADHU SRAVANTH, HYDERABAD (IN); ANKUR HAYATNAGARKAR, JALNA (IN)

(21) Appl. No.: 15/054,606

(22) Filed: Feb. 26, 2016

(51) Int. Cl. G06F 17/30

(52) U.S. Cl. CPC G06F 17/3097; G06F 17/30958; G06F 17/30991; G06F 17/3053; G06F 17/30551; G06F 17/30867

(57) ABSTRACT

Personalized experiences based on leisure interest identification are provided to a user. An enriched entity and attribute graph is created based on leisure entities or attributes extracted from digital data signals. The user data signals may include browser history, queries in searches, social media signals, or click data. Global data is utilized to crawl the enriched entity and attribute graph to infer entities or attributes. Based on the inferred entities or attributes, leisure suggestions can be ranked and provided to the user via a user device. Completion suggestions may additionally be provided to the user via the user device that enable the user to complete an activity associated with one or more of the leisure suggestions.

### BACKGROUND

People typically have interests in many different leisure activities, including movies, television (TV) programs, travel, books, and the like. Personal assistant services that attempt to predict activities for users face many challenges. First, interests among people can vary greatly. Although one person may be interested in movies, another person may dislike movies but enjoy TV programs. Yet another person may dislike both movies and TV programs, but prefers to read books. Even where commonality exists, there are many different entities comprising each activity. For example, each activity may comprise authors, directors, actors, and the like. Further each activity may have many different attributes, including genre, language, and the like. Second, predicting activities that vary so greatly among different users requires utilizing personal data. Unfortunately, this ignores global relationships among entities and attributes that may lead to additional activities that are of interest to the user. In other words, only known activities of interest (based on known entities and known attributes) can be identified. This leads to missed opportunities for both users and those that provide leisure activity opportunities.

### SUMMARY

This summary is provided to introduce a selection of concepts in a simplified form that are further described below in the detailed description. This summary is not intended to identify key features or essential features of the claimed subject matter, nor is it intended to be used in isolation as an aid in determining the scope of the claimed subject matter.

Embodiments of the invention are directed towards systems and methods for providing personalized experiences based on leisure interest identification. In particular, digital data signals of a user are utilized to identify favorite leisure entities or attributes. By way of example and not limitation, entities may include actors, directors, authors, destinations, performers, and the like. Attributes may include genres, languages, dates, times, prices, and the like. By identifying favorite leisure entities or attributes, an enriched entity and attribute graph may be created for the user. Global entity and attribute data (learned from all users) is utilized to crawl the enriched entity and attribute graph to infer entities or attributes. Based on the inferred entities or attributes, leisure suggestions can be ranked and provided to the user via a user device. Completion suggestions, which are learned automatically by a computer system using the user's digital data, may additionally be provided to the user via the user device that enable the user to complete an activity associated with one or more of the leisure suggestions.

### BRIEF DESCRIPTION OF THE DRAWINGS

Aspects of the invention are described in detail below with reference to the attached drawing figures, wherein:

FIG. 1 is a diagram depicting an example computing architecture suitable for implementing aspects of the invention;

FIG. 2 is a flow diagram of a method for extracting entities of interest in accordance with embodiments of the present invention;

FIG. 3 is a flow diagram of a method for providing personalized experiences to a user in accordance with embodiments of the present invention;

FIG. 4 is a flow diagram of a method for identifying related entities and attributes in accordance with embodiments of the invention;

FIG. 5 is a flow diagram of a method for providing personalized experiences to a user in accordance with embodiments of the present invention; and

FIG. 6 is a block diagram of an exemplary computing environment suitable for use in implementing an embodiment of the invention.

### DETAILED DESCRIPTION

The subject matter of aspects of the invention is described with specificity herein to meet statutory requirements. However, the description itself is not intended to limit the scope of this patent. Rather, the inventors have contemplated that the claimed subject matter might also be embodied in other ways, to include different steps or combinations of steps similar to the ones described in this document, in conjunction with other present or future technologies. Moreover, although the terms “step” and/or “block” may be used herein to connote different elements of methods employed, the terms should not be interpreted as implying any particular order among or between various steps herein disclosed unless and except when the order of individual steps is explicitly described.

As used herein, the term “favorite” includes a preference before all others of the same kind. For example, a user's favorite movie may be “Caddyshack.” In this way, the term “favorite” means the user prefers “Caddyshack” over other movies of the same kind (e.g., other golf or sports movies, other comedies, other Bill Murray movies, etc.). As used herein, the term “favorite” may also include things the user might like but might not be a preference before all others of the same kind. In this way, the term “favorite” can also include other movies of the same kind within a particular class (e.g., “Happy Gilmore,” other comedies, other Bill Murray movies, etc.).

As mentioned above, existing personal assistant services face many challenges when attempting to predict leisure activities for users. Interests among people vary greatly. While some people enjoy books, others may enjoy movies, travel, or TV programs. Even where commonality exists, there are many different entities (e.g., authors, directors, actors) comprising each activity. Each activity may have many different attributes (e.g., genre, language, etc.). Consequently, predicting activities that vary so greatly among different users requires utilizing personal data. Unfortunately, use of personal data ignores global relationships among entities and attributes that may lead to additional activities that are of interest to the user. In other words, only known activities of interest (based on known entities and known attributes) can be identified. This leads to missed opportunities for both users and those that provide leisure activity opportunities.

Aspects of the technology described herein are directed towards systems, methods, and computer storage media for, among other things, providing a user with leisure suggestions that is personalized and provided in an appropriate manner. An enriched entity and attribute graph is created based on leisure entities or attributes extracted from digital data signals. The user data signals may include browser history, queries in searches, social media signals, or click data. Global data is utilized to crawl the enriched entity and attribute graph to infer entities or attributes. Based on the inferred entities or attributes, leisure suggestions can be ranked and provided to the user via a user device. Completion suggestions may additionally be provided to the user via the user device that enable the user to complete an activity associated with one or more of the leisure suggestions. The completion suggestions, as used herein, are suggested tasks that may enable the user to perform a leisure suggestion.

Initially, a signal graph is created utilizing user data signals. The link structure of the signal graph can then be explored to identify entities of interest. As explained in more detail below, an algorithmic task extraction is utilized to extract entities from query and browsing histories. This enables the tasks that others do to be identified using learning algorithms on the extracted data. These may be learned by seeding with a few known tasks and context words. A framework which takes the initial seed tasks and does natural language processing and entity detection on queries from search logs facilitates finding the additional tasks. Top providers may additionally be identified for task completion. A chronological task time line may also be identified (e.g., planning travel may require certain tasks, including booking tickets, hotels, checking weather, finding sight-seeing activities, etc. and may include in some order). This task time line may be learned by looking at the browsing sessions and understanding the association rules between tasks and chronological ordering through temporal association rule mining.

In an example, a user may query “nearest volcano in Seattle.” The inference system, described below, identifies Seattle is a place and volcano is a constraint. The inference system is able to identify various tasks related to, for example, planning a trip to Mt. Rainier.

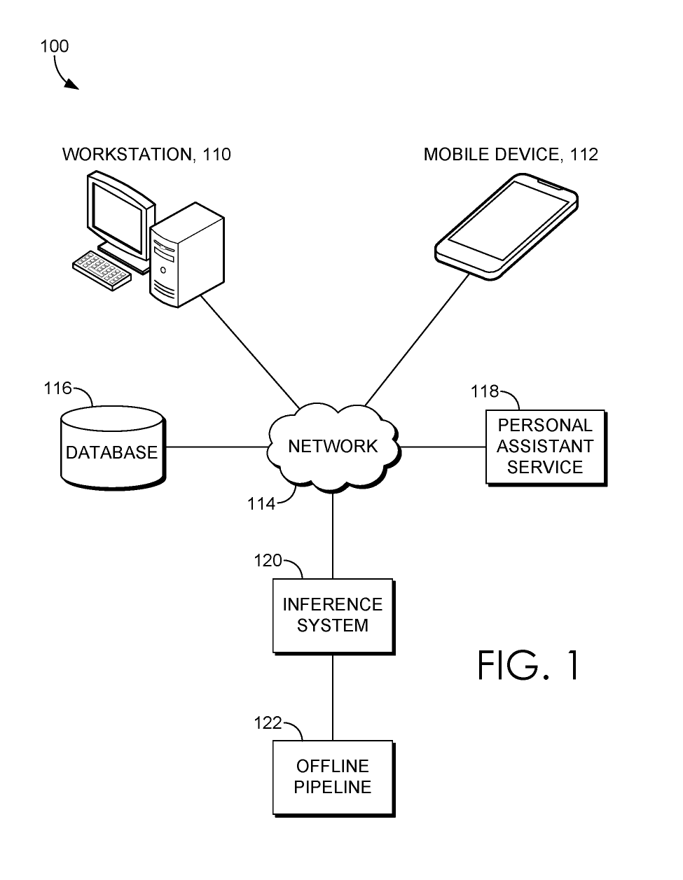

Turning now to FIG. 1, a block diagram is provided showing an example computing architecture suitable for implementing embodiments of the present and is designated generally as system 100. It should be understood that this and other arrangements described herein are set forth only as examples. System 100 represents only one example of a suitable computing system architecture. Other arrangements and elements can be used in addition to or instead of those shown, and some elements may be omitted altogether for the sake of clarity. Further, many of the elements described herein are functional entities that may be implemented as discrete or distributed components or in conjunction with other components, and in any suitable combination and location. Other arrangements and elements (e.g., machines, interfaces, functions, orders, and groupings of functions, etc.) can be used in addition to or instead of those shown, and some elements may be omitted altogether for the sake of clarity. Various functions described herein as being performed by one or more entities may be carried out by hardware, firmware, and/or software. For instance, some functions may be carried out by a processor executing instructions stored in memory.

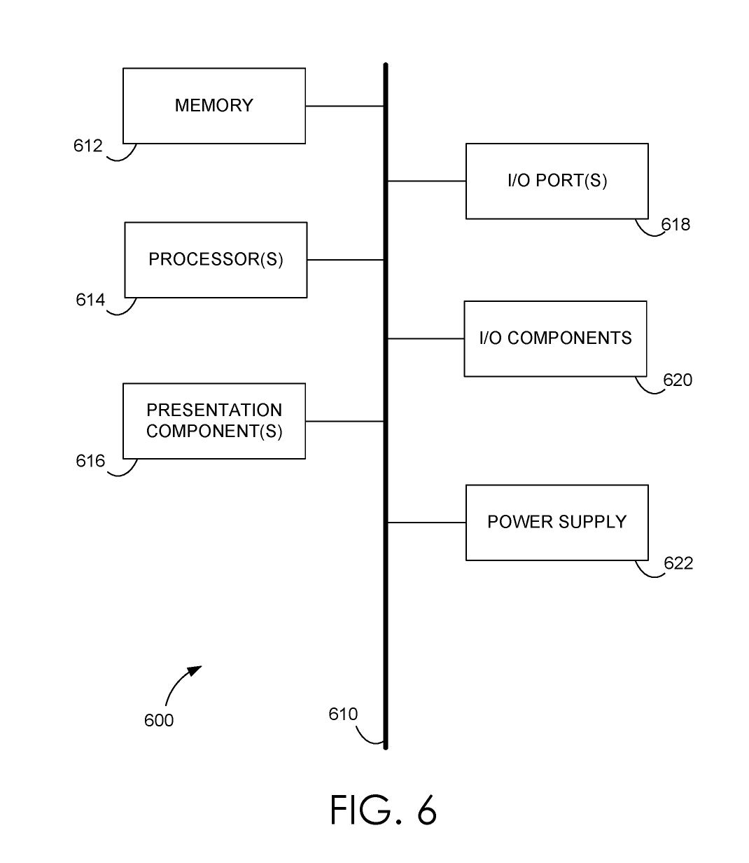

Among other components not shown, example system 100 includes a number of user devices, such as workstation 110 and mobile device 112; a data source, such as database 116; personal assistant service 118; inference system 120; offline pipeline 122; and network 114. It should be understood that system 100 shown in FIG. 1 is an example of one suitable architecture. Each of the components shown in FIG. 1 may be implemented via any type of computing device, such as computing device 600 described in connection to FIG. 6, for example. These components may communicate with each other via network 114, which may include, without limitation, one or more local area networks (LANs) and/or wide area networks (WANs). In exemplary implementations, network 114 comprises the Internet and/or a cellular network, amongst any of a variety of possible public and/or private networks. In embodiments, personal assistant service 118, inference system 120, and offline pipeline 122 may be embodied as a set of compiled computer instructions or functions, program modules, computer software services, or an arrangement of processes carried out on one or more computer systems, such as computing device 600 described in connection to FIG. 6, for example.

It should be understood that any number of user devices, servers, and data sources may be employed within system 100 within the scope of the present disclosure. Each may comprise a single device or multiple devices cooperating in a distributed environment. For instance, inference system 120 may be provided via multiple devices arranged in a distributed environment that collectively provide the functionality described herein. Additionally, other components not shown may also be included within the distributed environment.

Workstation 110 and mobile device 112 can be client devices on the client-side of system 100, while personal assistant service 118, inference system 120, and offline pipeline 122 can be on the server-side of system 100. Personal assistant service 118, inference system 120, and offline pipeline 122 can comprise server-side software designed to work in conjunction with client-side software on workstation 110 and mobile device 112 so as to implement any combination of the features and functionalities discussed in the present disclosure. This division of system 100 is provided to illustrate one example of a suitable computing architecture, and there is no requirement for each implementation that any combination of workstation 110, mobile device 112, personal assistant service 118, inference system 120, and offline pipeline 122 remain as separate entities.

Workstation 110 and mobile device 112 may comprise any type of computing device capable of use by a user. For example, in one embodiment, user device 110 may be the type of computing device described in relation to FIG. 6 herein. By way of example and not limitation, workstation 110 and mobile device 112 may be embodied as a personal computer (PC), a laptop computer, a mobile or mobile device, a smartphone, a tablet computer, a smart watch, a wearable computer, a personal digital assistant (PDA), an MP3 player, a global positioning system (GPS) or device, a video player, a handheld communications device, a gaming device or system, an entertainment system, a vehicle computer system, an embedded system controller, a remote control, an appliance, a consumer electronic device, a workstation, or any combination of these delineated devices, or any other suitable device.

Database 116 may comprise data sources and/or data systems, which are configured to make data available to any of the various constituents of operating environment 100. (For example, in one embodiment, database 116 provides (or makes available for accessing) user data to personal assistant service 118, inference system 120, or offline pipeline 122.) Database 116 may be discrete from workstation 110, mobile device 112, personal assistant service 118, inference system 120, or offline pipeline 122 or may be incorporated and/or integrated into at least one of those components. In one embodiment, database 116 may comprise one or more sensors, which may be integrated into or associated with one or more of the workstation 110, mobile device 112, personal assistant service 118, inference system 120, or offline pipeline 122. Examples of sensed user data made available by database 116 are described further herein.

In one embodiment, the functions performed by components of system 100 are associated with one or more personal assistant applications, services, or routines. In particular, such applications, services, or routines may operate on one or more user devices (such as workstation 110 or mobile device 112), servers (such as personal assistant service 118), may be distributed across one or more user devices and servers, or be implemented in the cloud. Moreover, in some embodiments, these components of system 100 may be distributed across a network, including one or more servers (such as personal assistant service 118, inference system 120, and offline pipeline 122) and client devices (such as workstation 110 or mobile device 112), in the cloud, or may reside on a user device, such as workstation 110 or mobile device 112.

Moreover, these components, functions performed by these components, or services carried out by these components may be implemented at appropriate abstraction layer(s) such as the operating system layer, application layer, hardware layer, etc., of the computing system(s). Alternatively, or in addition, the functionality of these components and/or the embodiments of the invention described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. Additionally, although functionality is described herein with regards to specific components shown in example system 100, it is contemplated that in some embodiments functionality of these components can be shared or distributed across other components.

Continuing with FIG. 1, offline pipeline 122 is generally responsible for accessing or receiving (and in some cases also identifying) user data from one or more data sources, such as user search history, social media signals, and the like. In some embodiments, offline pipeline 122 is employed to facilitate the accumulation of user data of one or more users. The data may be received (or accessed), and optionally accumulated, reformatted, and/or combined, by offline pipeline 122 and stored in one or more data stores such as database 116, where it may be available to inference system 120 and personal assistant service 118. For example, the user data may be stored in or associated with an enriched entity and attribute graph, as described herein. Additionally, global data from one or more users may be stored in a data store, such as database 116, as global entity and attribute data. In some embodiments, any personally identifying data (i.e., user data that specifically identifies particular users) is either not uploaded from the one or more data sources with user data, is not permanently stored, and/or is not made available to inference system 120 and personal assistant service 118.

User data may be received from a variety of sources where the data may be available in a variety of formats. For example, in some embodiments, user data received via offline pipeline 122 may be determined via one or more sensors, which may be on or associated with one or more user devices (such as workstation 110 or mobile device 112), servers (such as personal assistant service 118, inference system 120, or offline pipeline 122), and/or other computing devices. As used herein, a sensor may include a function, routine, component, or combination thereof for sensing, detecting, or otherwise obtaining information, and may be embodied as hardware, software, or both.

By way of example and not limitation, user data may include data that is sensed or determined from one or more sensors (referred to herein as digital data signals), such as location information of mobile device(s), smartphone data (such as phone state, charging data, date/time, or other information derived from a smartphone), user-activity information (for example: app usage; online activity; searches; voice data such as automatic speech recognition; activity logs; communications data including calls, texts, instant messages, and emails; website posts; other user data associated with communication events; etc.) including user activity that occurs over more than one user device, user history, session logs, application data, contacts data, calendar and schedule data, notification data, social network data, news (including popular or trending items on search engines or social networks), online gaming data, ecommerce activity (including data from online accounts such as Microsoft®, Amazon.com®, Google®, eBay®, PayPal®, video-streaming services, gaming services, or Xbox Live®), user-account(s) data (which may include data from user preferences or settings associated with a personal assistant application or service), home-sensor data, appliance data, global positioning system (GPS) data, vehicle signal data, traffic data, weather data (including forecasts), wearable device data, other user device data (which may include device settings, profiles, network connections such as Wi-Fi network data, or configuration data, data regarding the model number, firmware, or equipment, device pairings, such as where a user has a mobile phone paired with a Bluetooth headset, for example), gyroscope data, accelerometer data, payment or credit card usage data (which may include information from a user's PayPal account), purchase history data (such as information from a user's Amazon.com or eBay account), other sensor data that may be sensed or otherwise detected by a sensor (or other detector) component including data derived from a sensor component associated with the user (including location, motion, orientation, position, user-access, user-activity, network-access, user-device-charging, or other data that is capable of being provided by one or more sensor component), data derived based on other data (for example, location data that can be derived from Wi-Fi, cellular network, or IP address data), and nearly any other source of data that may be sensed or determined as described herein.

In some respects, user data may be provided in user-data streams or signals. A “digital data signal” can be a feed or stream of user data from a corresponding data source. For example, a digital data signal could be from a smartphone, a home-sensor device, a GPS device (e.g., for location coordinates), a vehicle-sensor device, a wearable device, a user device, a gyroscope sensor, an accelerometer sensor, a calendar service, an email account, a credit card account, or other data sources. In some embodiments, offline pipeline 122 receives or accesses data continuously, periodically, or as needed.

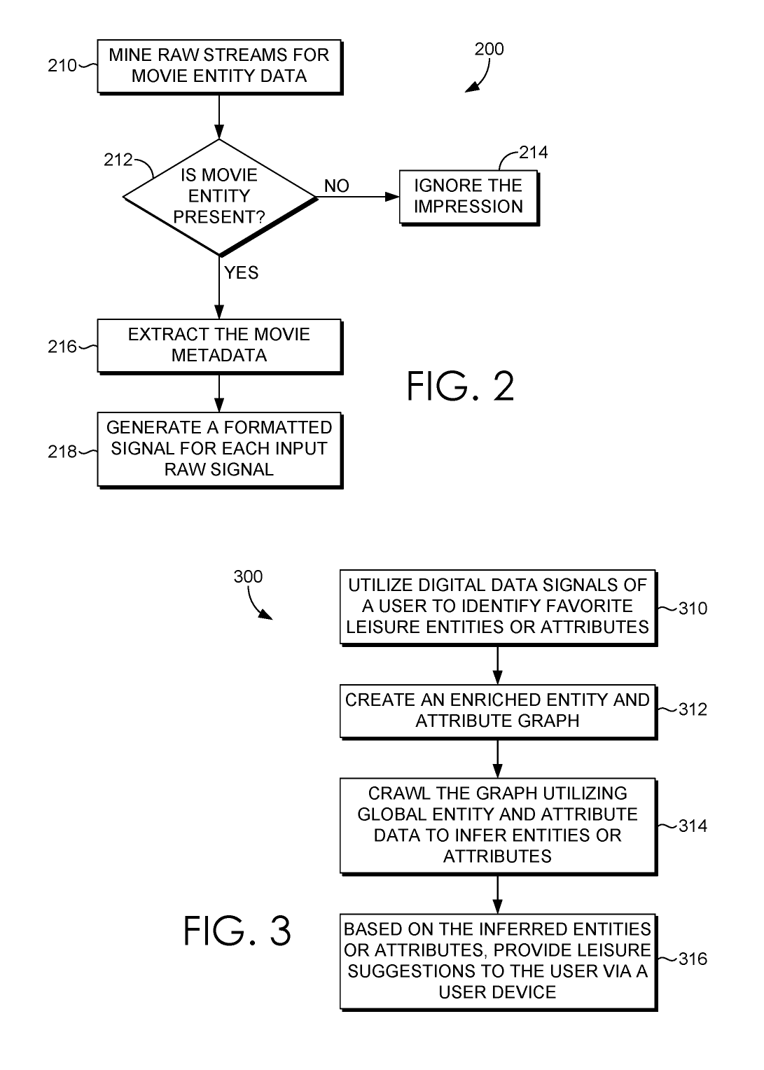

Inference system 120 is generally responsible for utilizing the digital data signals to create an enriched entity and attribute graph. Initially, nodes of the enriched entity and attribute graph include entities and attributes derived from digital data signals for the user. Turning to FIG. 2, a flow diagram of a method for extracting entities of interest in accordance with embodiments of the present invention is illustrated. As shown in FIG. 2, raw streams are mined for entity data (e.g., movie data, music data, or any category of interest) at step 210. The raw streams may be any type of digital data signal described herein. If no entity is present, as shown at step 214, that particular impression is ignored. If an entity is present, the metadata is extracted at step 216. The metadata may include the type of entity (e.g., movie name, actor, director, etc.). Attributes (e.g., language, genre, etc.) may also be included with the metadata. At step 218, a formatted signal is generated for each input raw signal. These signals may be stored as interim data for each user and are utilized to create the enriched entity and attribute graph. In some embodiments, the interim data is generated on a regular basis, for example, daily. In some embodiments, the battery signal of a user device (e.g., the workstation 110 or mobile device 112 of FIG. 1) is utilized to initialize the mining process.

In embodiments, one pipeline is implemented by the inference system 120 for each inference. For example, a favorite movie inference may output a user's favorite movie schema. Similarly, a favorite actor inference may output a user's favorite actors. A favorite attribute inference outputs a user's favorite movie attributes (e.g., genre, language, etc.). As explained in more detail below, the base algorithm driving all inference utilizes interim data to construct an entity relation graph across all movie entities. Assigned prior probabilities are based on click data and other signals. Customized walks on the graph are employed to derive movie entities of interest. A link structure is constructed in the way because movie entities are typically related to one another (e.g. one actor may have appeared in multiple movies). Thus, a link structure in the graph with one search on the actor, as well as several signals referring to other movie entities, may indirectly indicate a user's interest in the actor. Exploring such links can reveal useful and better inference insights. Additional filtering may be applied to these customized walks on the graph to re-prioritize as needed. Any corresponding schemas based on the needed inference/entity type may be provided.

Referring back to FIG. 1, the enriched entity and attribute graph is utilized by inference system 120 to identify related entities and attributes the user may be interested in. Initially, the entities and attributes extracted by inference system 120 are utilized to seed the enriched entity and attribute graph. The graph may be expanded around the seeds (i.e., extracted entities and attributes) resulting in an unwinded graph containing relevant entities and attributes on each node. To obtain the unwinded graph, the following algorithm may be utilized:

1. Start with S₀={given entity} and entityGraph={Empty}, i=0.

2. Add S₀ to entityGraph.

3. While i<Max_Number_Of_Unwindings do Step 4, otherwise go to step 5.

4. For each node X in Sᵢ that is not explored so far (ordered by clicks served).
a. Identify all the outgoing edges E(X) of X (say Y^{M}), sorted based on the edge weights (or clicks leading to this node, X). Select top “UMax” such edges, say Y^{Umax} (Umax=10 currently). This step leads to identifying top Umax entities/attributes which drive us to X (entity/attribute).
b. Add the new nodes identified as above, i.e Y^{Umax}, to S₍ᵢ₊₁₎ and update the click data of node as well as edges and add this to entityGraph.
c. Mark X as explored.
d. i=i+1

5. return entityGraph.

Once the enriched entity and attribute graph is created by inference system 120, initial probabilities may be assigned to each node. Global user data may be used to assign the initial probabilities to each node. In embodiments, the initial probabilities consider: 1) how strongly the node is connected to the original seed(s); 2) how strongly the node is a candidate that would be explored based on the click data based on a community of users; 3) nodes that have higher clicks have more probably chance of being explored; and 4) the inherent relativity between entities and attributes.

Considering the above factors, an initial probability distribution may be proposed. For a given node, N, an initial probability is assigned as:

P(N)=αPrior(N)+(1−α)*f(→N)

Intuitively, this means that every node has a prior probability but the initial probability is a function of its prior as well as the neighbors (i.e., →N, which represents edges leading to N). P(N) is defined as 1 for all seed nodes (i.e., given entities for which we need related information), which enforces strong affinity to start. Every other node has the probability defined by the formulation:

$$P ( N ) = {Max}_{∀ X \to N} \{ α ⋆ P ( X ) + ( 1 - α ) ⋆ \frac{weight ( X \to N )}{\sum weight ( Xi \to N )} ⋆ P ( X )$$

For every edge Xi leading to N, the above values are identified by inference system 120 for all predecessors of N; maximum value is propagated as initial probability of the node N. The above formulation ensures that every node passes its prior to next node, and prior is decided based on max strength predecessor. Hence, the first part of the formulation α* helps meet the first precondition above.

The second part of formulation (i.e., (1−α)*), is based on the observation that the probability of some random walker coming from Xᵢ to N is based on the strength of an edge in relation to other possible edges. Thus, click data is utilized by the inference system 120 to meet the second and third pre-conditions, above. Intuitively, a node passes on its probability to successors based on these pre-conditions.

Once initial probabilities are formed by the inference system 120, prior information of known entity types can be utilized to boost probabilities (e.g., similar movies, actors, directors, etc.). To achieve this, a boosting function is defined on the above initial probability. So the initial probabilities can be boosted as follows:

P′(N)=Boost(P(N))

Boost(P(N))=Min{(1+β*Corr(N,givenEntities))*P(N),1}, where Value of β decides how much to boost (e.g., 0.25)

Data of all users may be mined by the inference system 120 to identify how correlated two entities may be. This data may be utilized to derive correlations, and then a clustering algorithm can be utilized on these correlations (agglomerative hierarchical clustering). The output is clusters of similar entities.

$$\begin{matrix}Corr ( N , givenEntities ) = 1 , & if N is in same cluster as any of givenUrls . \\ = 0 , & otherwise .\end{matrix}$$

Once the initial probability distributions and link structure have been created by the inference system 120, there are several ways to find related entities. In one embodiment, all the nodes are ranked in a relation graph in decreasing order. The top entities are selected and represent the related entities without requiring link exploration. Although this provides good results, no link structure is explored. In some embodiments, the graph is considered as a Markov chain and a random walker is simulated starting from the seed. By determining how to reach the steady state probability, a ranked list of nodes results. This involves converting the relation graph to (column) stochastic probability matrix and initial probabilities on nodes become an initial, normalized rank. In one embodiment, iterative solution of finding the dominant Eigen vector (like page rank) is utilized. In another embodiment, the link structure is explored to figure out the authorities and hub scores of each node in the graph. This is again an iterative formulation, until steady states are reached.

Once a ranked list of nodes based on prior probabilities and steady state probability derivation is obtained by the inference system 120, the related entities can be provided to the end user by personal assistant service 118. The results can then further ranked and pruned. In this way, false positives are pruned and intent classification and distance metrics are utilized. The final output may be a ranked list of entities which match the user intent.

Referring still to FIG. 1, once inference system 120 has identified related entities, it can also extract tasks for entities of interest. These tasks may be associated to an entity and/or an activity. To do so, natural language processing and entity detection on queries from search logs are performed on the related entities to identify tasks. In embodiments, tasks, subjects, objects, and/or constraints are extracted from any natural language data and a reverse map is created to a known set of tasks based on algorithmic matching. For each task, the inference system 120 identifies the top providers for task completion by analyzing click data of the query logs. In embodiments, the task providers may be websites, apps, etc. Additionally or alternatively, the tasks and providers may be identified based on context, such as by identifying the contextual words with each task which can later be used in a natural language query for task conversion.

A chronological task time line may also learned by inference system 120. In an example, a certain leisure activity (e.g., travel) requires multiple tasks (e.g., booking tickets and hotel, checking weather, finding sight-seeing activities, etc. with each activity being performed in a typical order). Each of these tasks for an activity completion template that may be learned by inference system 120 by analyzing browsing sessions and understanding the association rules between tasks and chronological ordering through temporal association rule mining.

In FIG. 3, a flow diagram of a method for providing personalized experiences to a user in accordance with embodiments of the present invention. Each block or step of method 400 and other methods described herein comprises a computing process that may be performed using any combination of hardware, firmware, and/or software. For instance, various functions may be carried out by a processor executing instructions stored in memory. The methods may also be embodied as computer-usable instructions stored on computer storage media. The methods may be provided by a stand-alone application, a service or hosted service (stand-alone or in combination with another hosted service), or a plug-in to another product, to name a few.

As shown in FIG. 3, digital data signals of a user are utilized, at step 310, to identify favorite leisure entities or attributes. In embodiments, the digital data signals comprise browser history, queries in searches, social media signals, or click data. In embodiments, movie related attributes of interest, the attributes including genres, languages, preferred runtime, or social media likes are identified. In some embodiments, the digital data signals are aggregated from various sources. The favorite leisure entities or attributes may be extracted from the digital data signals and stored as interim data.

An enriched entity and attribute graph is created for the user, at step 312. The enriched entity and attribute graph may be updated based on updates to the digital data signals of the user. In embodiments, the enriched entity and attribute graph is created utilizing the interim data. Global entity and attribute data is utilized, at step 314, to crawl the enriched entity and attribute graph and infer entities or attributes. In some embodiments, a battery signal of the user device triggers the crawling.

Probabilities may be assigned to the entities or attributes in the enriched entity and attribute graph. The inferred entities or attributes may be ranked and/or stored. One or more personal data stores may be created for the user and utilized to store the inferred entities or attributes. In some embodiments, the ranking takes time frame of the digital signals into account. Based on the inferred entities or attributes, leisure suggestions are provided, at step 316, to the user via a user device. Completion suggestions may be provided to the user based on the leisure suggestions.

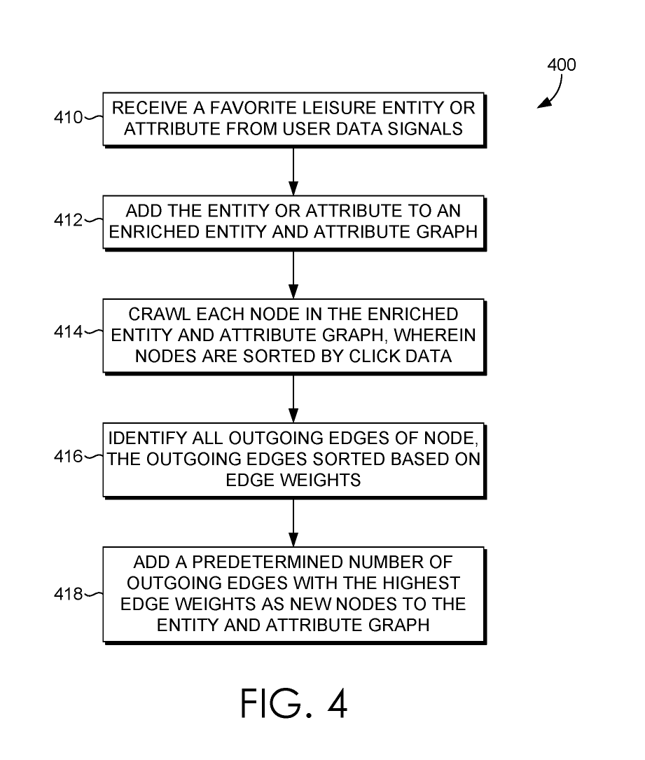

Turning now to FIG. 4, a flow diagram is provided illustrating one example method 400 for creating and crawling an enriched entity and attribute graph. At step 410, a favorite leisure entity or attribute is received from user data signals. The user data signals may include browser history, queries in searches, social media signals, or click data. The entity or attribute is added, at step 412, to an enriched entity and attribute graph. Each node in the enriched entity and attribute graph is crawled, at step 414, utilizing global entity and attribute data. Nodes may be sorted by click data, popularity, scores, or a combination thereof.

At step 416, all outgoing edges of each node are identified. The outgoing edges may be sorted based on edge weights. A predetermined number of outgoing edges are added, at step 418, with the highest edge weights as new nodes to the entity and attribute graph. In embodiments, a probability is assigned to each node in the entity and attribute graph. Leisure suggestions may be provided to a user based on the probability. Completion suggestions may be provided to the user based on the leisure suggestions.

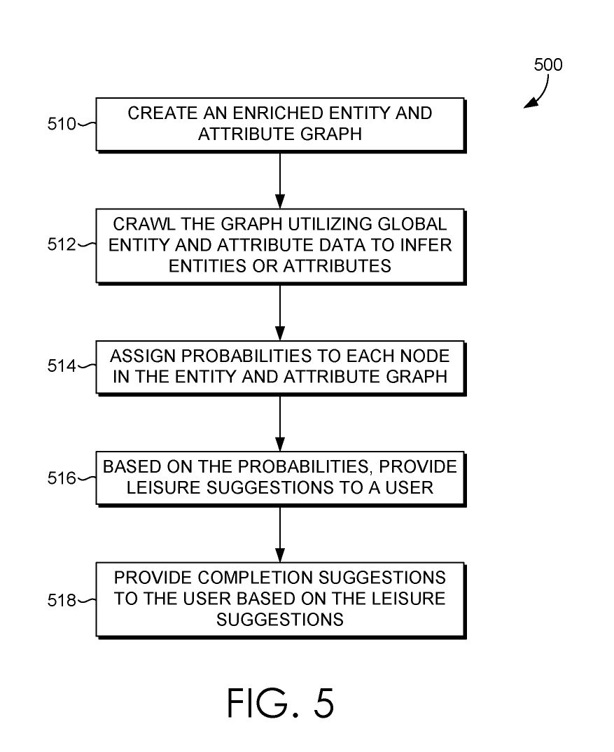

With reference now to FIG. 5, a flow diagram is provided illustrating one example method 500 for proactive favorite leisure interest identification for personalized experiences. At step 510, an enriched entity and attribute graph is created. The graph is crawled, at step 512, utilizing machine learning and statistical methods, as described herein, to infer entities or attributes. Probabilities are assigned, at step 514, to each node in the entity and attribute graph. Based on the probabilities, leisure suggestions are provided to a user, at step 516. Completion suggestions are provided to the user, at step 518, based on the leisure suggestions.

Accordingly, we have described various aspects of technology directed to systems and methods for providing personalized experiences to a user. It is understood that various features, sub-combinations, and modifications of the embodiments described herein are of utility and may be employed in other embodiments without reference to other features or sub-combinations. Moreover, the order and sequences of steps shown in the example methods 200, 300, 400, and 500 are not meant to limit the scope of the present invention in any way, and in fact, the steps may occur in a variety of different sequences within embodiments hereof. Such variations and combinations thereof are also contemplated to be within the scope of embodiments of the invention.

With reference now to system 100, and methods 200, 300, 400, and 500 (FIGS. 1-5), several additional examples are described for providing personalized experiences based on leisure interest identification. These examples may be carried out using various embodiments of the invention described herein. In a first example, a user's favorite movie actor entities (e.g., Leonardo DeCaprio, James Cameron, etc.) or movie genres (e.g., action, romance, science-fiction, etc.) may be identified or inferred. Based on these inferences, any computing environment (e.g., digital assistants like Cortana) can provide proactive movie recommendations, which may include presenting show times to the user when the user may have free-time (e.g., weekends, after work, or based on availability noted in an electronic calendar) or presenting trailers proactively as a notification. By using the inferred favorite entities, the experiences can be personalized for each user. The same can be used in personalization of search engine results and other areas.

In a second example, favorite music artist entities (e.g., Bryan Adams, Metallica (band), etc.) or music genres (e.g., rock, classical, etc.) may be identified. These entities may be utilized to provide music recommendations that are personalized. Cortana or any proactive assistant can automatically select user's choice of music based on these inferred entities/attributes and present to the user either in a proactive way or reactively when asked.

In a third example, favorite book authors of interest (e.g., J. K Rowling) or book genres (e.g., fiction) may be identified. These entities may be used to provide personalized book recommendations to user or may be used proactively to automatically select an electronic book or media content for the user to read (e.g., Cortana knows the user is flying on a business trip and likes to read inflight books or other media content and provides recommendations or makes selections based on this learned knowledge).

Having described various embodiments of the invention, an exemplary computing environment suitable for implementing embodiments of the invention is now described. With reference to FIG. 6, an exemplary computing device is provided and referred to generally as computing device 600. The computing device 600 is but one example of a suitable computing environment and is not intended to suggest any limitation as to the scope of use or functionality of the invention. Neither should the computing device 600 be interpreted as having any dependency or requirement relating to any one or combination of components illustrated.

Embodiments of the invention may be described in the general context of computer code or machine-useable instructions, including computer-useable or computer-executable instructions, such as program modules, being executed by a computer or other machine, such as a personal data assistant, a smartphone, a tablet PC, or other handheld device. Generally, program modules, including routines, programs, objects, components, data structures, and the like, refer to code that performs particular tasks or implements particular abstract data types. Embodiments of the invention may be practiced in a variety of system configurations, including handheld devices, consumer electronics, general-purpose computers, more specialty computing devices, etc. Embodiments of the invention may also be practiced in distributed computing environments where tasks are performed by remote-processing devices that are linked through a communications network. In a distributed computing environment, program modules may be located in both local and remote computer storage media including memory storage devices.

With reference to FIG. 6, computing device 600 includes a bus 610 that directly or indirectly couples the following devices: memory 612, one or more processors 614, one or more presentation components 616, one or more input/output (I/O) ports 618, one or more I/O components 620, and an illustrative power supply 622. Bus 610 represents what may be one or more busses (such as an address bus, data bus, or combination thereof). Although the various blocks of FIG. 6 are shown with lines for the sake of clarity, in reality, these blocks represent logical, not necessarily actual, components. For example, one may consider a presentation component such as a display device to be an I/O component. Also, processors have memory. The inventors hereof recognize that such is the nature of the art and reiterate that the diagram of FIG. 6 is merely illustrative of an exemplary computing device that can be used in connection with one or more embodiments of the present invention. Distinction is not made between such categories as “workstation,” “server,” “laptop,” “handheld device,” etc., as all are contemplated within the scope of FIG. 6 and with reference to “computing device.”

Computing device 600 typically includes a variety of computer-readable media. Computer-readable media can be any available media that can be accessed by computing device 600 and includes both volatile and nonvolatile media, removable and non-removable media. By way of example, and not limitation, computer-readable media may comprise computer storage media and communication media. Computer storage media includes both volatile and nonvolatile, removable and non-removable media implemented in any method or technology for storage of information such as computer-readable instructions, data structures, program modules, or other data. Computer storage media includes, but is not limited to, RAM, ROM, EEPROM, flash memory or other memory technology, CD-ROM, digital versatile disks (DVDs) or other optical disk storage, magnetic cassettes, magnetic tape, magnetic disk storage or other magnetic storage devices, or any other medium which can be used to store the desired information and which can be accessed by computing device 600. Computer storage media does not comprise signals per se. Communication media typically embodies computer-readable instructions, data structures, program modules, or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media, such as a wired network or direct-wired connection, and wireless media, such as acoustic, RF, infrared, and other wireless media. Combinations of any of the above should also be included within the scope of computer-readable media.

Memory 612 includes computer storage media in the form of volatile and/or nonvolatile memory. The memory may be removable, non-removable, or a combination thereof. Exemplary hardware devices include solid-state memory, hard drives, optical-disc drives, etc. Computing device 600 includes one or more processors 614 that read data from various entities such as memory 612 or I/O components 620. Presentation component(s) 616 presents data indications to a user or other device. Exemplary presentation components include a display device, speaker, printing component, vibrating component, and the like.

The I/O ports 618 allow computing device 600 to be logically coupled to other devices, including I/O components 620, some of which may be built in. Illustrative components include a microphone, joystick, game pad, satellite dish, scanner, printer, wireless device, etc. The I/O components 620 may provide a natural user interface (NUI) that processes air gestures, voice, or other physiological inputs generated by a user. In some instances, inputs may be transmitted to an appropriate network element for further processing. An NUI may implement any combination of speech recognition, touch and stylus recognition, facial recognition, biometric recognition, gesture recognition both on screen and adjacent to the screen, air gestures, head and eye tracking, and touch recognition associated with displays on the computing device 600. The computing device 600 may be equipped with depth cameras, such as stereoscopic camera systems, infrared camera systems, RGB camera systems, and combinations of these, for gesture detection and recognition. Additionally, the computing device 600 may be equipped with accelerometers or gyroscopes that enable detection of motion. The output of the accelerometers or gyroscopes may be provided to the display of the computing device 600 to render immersive augmented reality or virtual reality.

Some embodiments of computing device 600 may include one or more radio(s) 624 (or similar wireless communication components). The radio 624 transmits and receives radio or wireless communications. The computing device 600 may be a wireless terminal adapted to receive communications and media over various wireless networks. Computing device 600 may communicate via wireless protocols, such as code division multiple access (“CDMA”), global system for mobiles (“GSM”), or time division multiple access (“TDMA”), as well as others, to communicate with other devices. The radio communications may be a short-range connection, a long-range connection, or a combination of both a short-range and a long-range wireless telecommunications connection. When we refer to “short” and “long” types of connections, we do not mean to refer to the spatial relation between two devices. Instead, we are generally referring to short range and long range as different categories, or types, of connections (i.e., a primary connection and a secondary connection). A short-range connection may include, by way of example and not limitation, a Wi-Fi® connection to a device (e.g., mobile hotspot) that provides access to a wireless communications network, such as a WLAN connection using the 802.11 protocol; a Bluetooth connection to another computing device is a second example of a short-range connection, or a near-field communication connection. A long-range connection may include a connection using, by way of example and not limitation, one or more of CDMA, GPRS, GSM, TDMA, and 802.16 protocols.

Many different arrangements of the various components depicted, as well as components not shown, are possible without departing from the scope of the claims below. Embodiments of the present invention have been described with the intent to be illustrative rather than restrictive. Alternative embodiments will become apparent to readers of this disclosure after and because of reading it. Alternative means of implementing the aforementioned can be completed without departing from the scope of the claims below. Certain features and sub-combinations are of utility and may be employed without reference to other features and sub-combinations and are contemplated within the scope of the claims.

What is claimed is:

1. Computer storage media having computer-executable instructions embodied thereon that, when executed by one or more computing devices, cause the one or more computing devices to perform a method of providing personalized experiences based on leisure interest identification, the method comprising:
utilizing digital data signals of a user to identify leisure entities or attributes;
creating an enriched entity and attribute graph for the user;
utilizing global entity and attribute data to crawl the enriched entity and attribute graph and infer entities or attributes; and
based on the inferred entities or attributes, providing leisure suggestions to the user via a user device.

2. The media of claim 1, further comprising identifying movie related attributes of interest, the attributes including genres, languages, preferred runtime, or social media likes.

3. The media of claim 1, further comprising ranking the inferred entities or attributes.

4. The media of claim 3, wherein the ranking takes time frame of the digital data signals into account.

5. The media of claim 1, wherein the digital data signals comprise browser history, queries in searches, social media signals, or click data.

6. The media of claim 1, further comprising aggregating the digital data signals.

7. The media of claim 1, further comprising providing completion suggestions to the user based on the leisure suggestions.

8. The media of claim 1, further comprising storing the inferred entities or attributes in a personal data store.

9. The media of claim 1, further comprising creating one or more personal data stores for the user, the one or more personal data stores including the inferred entities or attributes.

10. The media of claim 1, further comprising updating the enriched entity and attribute graph based on updates to the digital data signals of the user.

11. The media of claim 1, wherein the entities or attributes are extracted from the digital data signals and stored as interim data.

12. The media of claim 11, wherein the enriched entity and attribute graph is created utilized the interim data.

13. The media of claim 1, further comprising assigning probabilities to the entities or attributes in the enriched entity and attribute graph.

14. The media of claim 1, wherein a battery signal of the user device triggers the crawling.

15. A computerized method for creating and crawling an enriched entity and attribute graph, the method comprising:
receiving a leisure entity or attribute from user data signals;
adding the entity or attribute to an enriched entity and attribute graph;
crawling each node in the enriched entity and attribute graph utilizing global entity and attribute data, wherein nodes are sorted by click data, popularity, scores, or a combination thereof;
identifying all outgoing edges of each node, the outgoing edges sorted based on edge weights; and
adding a predetermined number of outgoing edges with the highest edge weights as new nodes to the entity and attribute graph.

16. The computerized method of claim 15, further comprising assigning a probability to each node in the entity and attribute graph.

17. The computerized method of claim 16, further comprising providing leisure suggestions to a user based on the probability.

18. The computerized method of claim 14, wherein the user data signals include browser history, queries in searches, social media signals, or click data.

19. The computerized method of claim 17, further comprising providing completion suggestions to the user based on the leisure suggestions.

20. A computerized system comprising one or more processors and computer storage media storing computer-useable instructions that, when used by the one or more processors, cause the one or more processors to:
create an enriched entity and attribute graph;
crawl the graph utilizing global entity and attribute data;
assign probabilities to each node in the entity and attribute graph;
based on the probabilities, provide leisure suggestions to a user; and
provide completion suggestions to the user based on the leisure suggestions.
